(19) United States
(12) Patent Application Publication
(10) Pub. No.: US 2009/0279158 A1
(43) Pub. Date: Nov. 12, 2009

(54) Fluid Actuator For Digitally Controllable Microfluidic Display

(75) Inventors: Eric Peeters, Mountain View, CA (US); Scott A. Uhland, Redwood City, CA (US); Frederick J. Endicott, San Carlos, CA (US)

Correspondence Address: BEVER, HOFFMAN & HARMS, LLP, 901 CAMPISI WAY, SUITE 370, CAMPBELL, CA, 95008, US

(73) Assignee: Palo Alto Research Center Incorporated, Palo Alto, CA (US)

(21) Appl. No.: 12/117,580

(22) Filed: May 8, 2008

(51) Int. Cl. G02B 26/02

(52) U.S. Cl. 359/228

(57) ABSTRACT

Microfluidic pixels are utilized to produce large format displays (billboards) that are both digitally controllable and are light weight. Each pixel includes a wall having a front (display) surface, and a microfluidic system including a reservoir disposed behind the wall, a colorant fluid, a transparent display chamber disposed in front of the wall, a conduit, and a fluid actuator. The reservoir includes a reservoir chamber including a deformable wall, and the fluid actuator includes a mechanism for selectively displacing the deformable wall such that a portion of the first colorant fluid is transferred between the first reservoir and the first display chamber through the first conduit, whereby the pixel's appearance changes between a background appearance determined by the color (e.g., white) of the front wall surface, and a “colored” appearance determined by the amount and color of the colorant fluid disposed in the display chamber.

### FIELD OF THE INVENTION

This invention relates to digital displays, and more particularly to light-weight and low-power pump structures for digitally controllable microfluidic displays.

### BACKGROUND OF THE INVENTION

A significant demand exists to transition conventional paper and paste or printed Vinyl advertisement billboards to digitally controllable displays. LED based billboards have started to infiltrate the market, but significant costs are incurred while regulations limit their market penetration. Opportunity exists for a lightweight, reflective and/or transmissive digital display technology that is capable of remote access for display changeover. Reflective digital displays also lack the ability to display the full color spectrum which is in high demand. Green displays using less energy are also critical to the consumer advertising market.

There are two primary ways used today to address this display need: traditional printed (passive and active) billboards, and LED (active) billboards.

The financial issues with printed billboards include the labor cost of changeover, insurance cost of changeover, and the frequency of changeover. Trivision has improved the cost structure somewhat through rotating/scrolling signs that allow for multi-messages on a single billboard. However, Trivision units are usually limited to three advertisements. A critical limitation of printed billboards is the fact that most billboard locations/structures are grandfathered in resulting in significant limitations on structure modification. Governments (federal through local) set these restrictions which, in many locations, limit additions and ultimately revenue. The main avenue to revenue growth is having the ability to display more advertising content at the most expensive locations, which is the driver for digitally changeable boards.

As a result, LED displays have entered the outdoor advertising market. The primary issues with LED boards are a product of the government regulations. Restrictions on structure modification do not allow for retrofitting to accommodate heavier billboard displays and/or light emitting boards. Grandfathered billboards exist under less restrictive regulations. Any required change to the support structure is an opportunity for local governments to reclassify it as a ‘new’ billboard structure, falling under the strict regulations. In many cases, this results in no new billboard “locations”. Additionally, LED boards require major changes to the support structures because of their weight. Examples exist where the digital LED billboard was too heavy to suspend off of a non reinforced highway overpass. Other needs/upgrades include major electrical specifications beyond the existing capabilities for lighting posters and/or active cooling. These are major barriers to upgrading printed posters with digital displays. Therefore, a significant opportunity exists in this market area for a lightweight digital display technology that could be mounted on existing structures without requiring additional facilities/construction. While not as significant, the high cost of a LED billboards is still important to note.

What is needed is a large format display (billboard) that is both digitally controllable (changeable) and has substantially (e.g., up to approximately ten times) the same weight to size ratio as conventional printed billboards.

### SUMMARY OF THE INVENTION

The present invention is directed to a fluid actuator (e.g., a pump) for controlling the flow of colorant fluid in a microfluidic pixel that is both light-weight and low-power, whereby a large format display (billboard) can be constructed using an array of the microfluidic pixels that is both digitally controllable (changeable) and has substantially the same weight to size ratio as conventional printed billboards. The term “microfluidic” is used herein to describe fluidic systems in which the quantity of colorant fluid displaced between the reservoir and the display chamber is in the range of 100 microliter or less.

In accordance with an embodiment of the present invention, each pixel of a large format display includes a wall having a front (display) surface, and a microfluidic system including a reservoir disposed on a rear side of the wall for storing the colorant fluid, at least one display chamber disposed in front of the wall (i.e., facing the front surface), a conduit that communicates between the reservoir and the display chamber, and the fluid actuator. In accordance with an aspect of the invention, the reservoir defines a reservoir chamber that is defined at least in part by a deformable wall (e.g., an elastomeric membrane), and the fluid actuator includes a mechanism capable of selectively displacing the deformable wall (e.g., into and out of the reservoir chamber), whereby a portion of the first colorant fluid is transferred between the reservoir chamber and the first display chamber through the conduit, thereby changing the appearance of the pixel. An advantage to forming the pixels using a deformable wall shared by the fluid actuator and the reservoir is that the microfluidic pixels are produced almost entirely using polymer or other light-weight materials, thereby facilitating production of large area displays with a size and weight that is suitable replacing existing printed billboards without requiring modification to existing support structures. Accordingly, by selectively controlling all of the microfluidic pixels making up the entire display surface, the present invention provides method for producing large format displays that are both digitally controllable (changeable) and can be utilized with existing “grandfathered” billboard support structures, thereby avoiding costly retrofitting or support replacement.

In accordance with an embodiment of the present invention, the display chamber of each pixel includes a transparent structure disposed over the front surface of the wall such that the front surface is only viewable through the display chamber, and the large format display includes a digital control circuit and a suitable active or passive matrix addressing backplane (or other wiring scheme) for selectively transmitting control signals to the fluid actuator of each pixel of the display. In response to a first control signal, a selected pixel's fluid actuator generates a force that displaces the deformable wall into the reservoir chamber. The resulting loss of volume in the reservoir chamber forces (transfers) a corresponding portion of the colorant fluid from the reservoir to the display chamber by way of the conduit, whereby the display surface portion of the selected pixel is changed to the “colored” appearance produced by the presence of colorant fluid in the display chamber. Conversely, upon receiving a second command signal from the digital control circuit, the fluid actuator generates a second force (or a cessation/absence of the first force plus a built-in restoring force, such as stiffness of diaphragm, tension in membrane, or static overpressure on the other side) that pulls (draws) the deformable wall out of the reservoir chamber, thereby decreasing the pressure inside the reservoir chamber such that the colorant fluid is drawn back into reservoir chamber, whereby the display surface portion of the selected pixel is changed to the “background” appearance produced by the front surface of the wall. Because the selected appearance is generated by the presence or absence of the colorant fluid in the display chamber, large format displays may be produced in accordance with the present invention that exhibit much lower power consumption than LED displays.

In accordance with alternative embodiments of the present invention, the fluid actuator of each pixel is implemented using a mechanism that only consumes power during an appearance change (i.e., between the “background” appearance and the “colored” appearance), and facilitates maintaining the selected appearance without requiring applied power. In accordance with a disclosed electrochemical embodiment, the fluid actuator of each pixel includes a rigid wall that cooperates with the deformable wall of the pixel's reservoir to define a pump chamber for containing an aqueous solution. Two electrodes are disposed inside the pump chamber, and a current source is used to apply predetermined potentials to the electrodes in response to corresponding control signals. To cause a selected pixel to change from its background (e.g., white) appearance to a color defined at least in part by a selected colorant fluid, a first digital control signal is transmitted to the selected pixel's current source, which applies a first potential across the electrodes that generates a first current in the aqueous solution, whereby hydrogen and oxygen (gas) bubbles are generated inside the pump chamber by way of water hydrolysis. The hydrogen and oxygen bubbles serve to increase pressure inside the pump chamber, and thereby apply a predetermined actuation force against the deformable wall. The deformable wall is thereby displaced into the reservoir chamber, forcing the colorant fluid out of the reservoir chamber and through the conduit into the display chamber disposed in front of the wall, thereby changing the display “color” from the white of the front wall surface to a color defined at least in part by the colorant fluid. To cause the pixel to return to its original background (e.g., white) appearance, a second digital control signal is transmitted to the fluid actuator's current source, which electrically shorts the two electrodes together, causing the hydrogen and oxygen gas to condense back into water (in presence of catalyst), thereby reducing the volume of the fluid in the pump reservoir. The deformable wall is thereby displaced out of the reservoir chamber, whereby a vacuum is generated in the reservoir chamber that draws the colorant fluid out of the display chamber and behind the front surface wall, thereby changing the display appearance back to the white background appearance. In addition to facilitating production of digitally controllable large format displays using low-cost lamination techniques and light weight materials, an advantage of this electrochemical pump configuration is that the deformable wall remains stable in either operating state as long as the electrodes are isolated (floating), thereby allowing the resulting displays to be operated with very low power consumption in comparison to LED displays. In other embodiments, the fluid actuator may be implemented using, e.g., one of a piezoelectric mechanism, a differential (bimetallic) thermal expansion mechanism, a shape memory alloy mechanism, electro-osmotic, thermopneumatic, hydrogel actuators, and valve array plus static pressure source, or other microfluidic actuation mechanisms known to those skilled in the art.

In accordance with a specific embodiment of the present invention, the pump chamber of each pixel includes a first chamber portion having the two electrodes disposed therein, a second chamber portion defined in part by the deformable wall, and a small conduit communicating between the first chamber portion and the second chamber portion. The two electrodes extend vertically within the first chamber portion, which is elongated in the vertical direction, and the small conduit is disposed at a lower end of the first chamber portion. With this arrangement, the converted hydrogen and oxygen gas forms a bubble that is confined within the first chamber portion such that the bubble remains in contact the two electrodes, thereby facilitating reliable reconversion of the gas into water.

According to another embodiment of the present invention, the colorant fluid of each pixel is translucent, and the digital control circuit is capable of controlling the duration of pump actuation of each of the pixels such that the corresponding display surface portion is selectively changeable between a relatively light shade, a relatively dark shade, and a medium shade that is between the relatively light shade and the relatively dark shade.

According to various specific embodiments, the microfluidic pixels of the present invention are selectively constructed to include one of a bladder-type display chamber and a diaphragm-type display chamber. A bladder-type pixel includes an elastomeric membrane having a peripheral edge that is secured to the front surface of the wall and deforms outward when colorant fluid forced into a pocket defined between the front surface and the membrane. To facilitate colorant fluid flow into the pocket, the conduit between the reservoir and the display chamber is implemented by micro-channels that pass through the wall. A diaphragm-type pixel includes a “baggie-type” membrane is disposed in a fixed volume chamber defined by a peripheral frame, a rigid transparent wall and the white front wall surface, whereby outward expansion of the “baggie-type” membrane is restricted by the rigid transparent wall, thus the displayed color achieves a more uniform appearance than that of the bladder-type pixel. A diaphragm-type color (e.g., CMY) pixel is formed by stacking two or more “baggie-type” display chambers onto the wall in a spatially serial arrangement, with each display chamber communicating with an associated reservoir by an associated conduit, and each display chamber being controlled by an associated fluid actuator in response to an associated control signal. In other embodiments, the microfluidic pixels of the present invention are selectively constructed using gravity filled display chambers or “sponge” type display chambers.

Each color pixel requires three distinct actuation currents for a unique CMY color. According to an embodiment of the invention, these three control signals are transmitted using a passive or active matrix addressing arrangement in which each positive electrode of each pixel is connected to a (e.g., horizontal) first conductor and each negative electrode is connected to an orthogonally arranged (e.g., vertical) second conductor. The electrochemical energy at each pixel is supplied through a set of localized capacitors in order to reduce the instantaneous power requirements. In one embodiment, the positive electrode of each pixel is constructed using a series of thin films providing a platinum surface as a catalyst for oxygen generation. Below the platinum layer, a series of metallization and dielectric layers are implemented in a capacitive structure. A diode or transistor may also be in series with the electrochemical cell in order to control current flow within the matrix structure.

### BRIEF DESCRIPTION OF THE DRAWINGS

These and other features, aspects and advantages of the present invention will become better understood with regard to the following description, appended claims, and accompanying drawings, where:

FIGS. 1(A) and 1(B) are cross-sectional side views showing a microfluidic pixel in two operating states according to an embodiment of the present invention;

FIGS. 2(A) and 2(B) are front views showing the pixel of FIGS. 1(A) and 1(B), respectively;

FIG. 3 is a front side perspective view showing a large format display according to a simplified general embodiment of the present invention;

FIGS. 4(A), 4(B) and 4(C) are cross-sectional side views showing an electrochemical pump of the large format display of FIG. 1 according to a simplified specific embodiment of the present invention;

FIGS. 5(A) and 5(B) are simplified cross-sectional side views showing a bladder-type pixel utilizing an electrochemical pump according to a simplified specific embodiment of the present invention;

FIGS. 6(A), 6(B) and 6(C) are front views showing the pixel of FIGS. 5(A) and 5(B) during operation;

FIGS. 7(A) and 7(B) are simplified cross-sectional side views showing a diaphragm-type pixel utilizing an electrochemical pump according to another simplified specific embodiment of the present invention;

FIGS. 8(A) and 8(B) are front views showing the pixel of FIGS. 7(A) and 7(B) during operation;

FIG. 9 is a simplified cross-sectional side view showing a color diaphragm-type pixel utilizing three electrochemical pumps according to another simplified specific embodiment of the present invention;

FIG. 10 is a simplified front view showing the color diaphragm-type pixel of FIG. 9 in additional detail;

FIG. 11 is simplified schematic diagram showing a simplified passive matrix addressing circuit of a large format display according to another embodiment of the present invention; and

FIG. 12 is simplified cross-sectional view showing an electrochemical pump according to another embodiment of the present invention.

### DETAILED DESCRIPTION OF THE DRAWINGS

The present invention relates to an improvement in large format displays. The following description is presented to enable one of ordinary skill in the art to make and use the invention as provided in the context of a particular application and its requirements. As used herein, directional terms such as “upper”, “upwards”, “lower”, “downward”, “front”, “back”, and “rear” are intended to provide relative positions for purposes of description, and are not intended to designate an absolute frame of reference. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

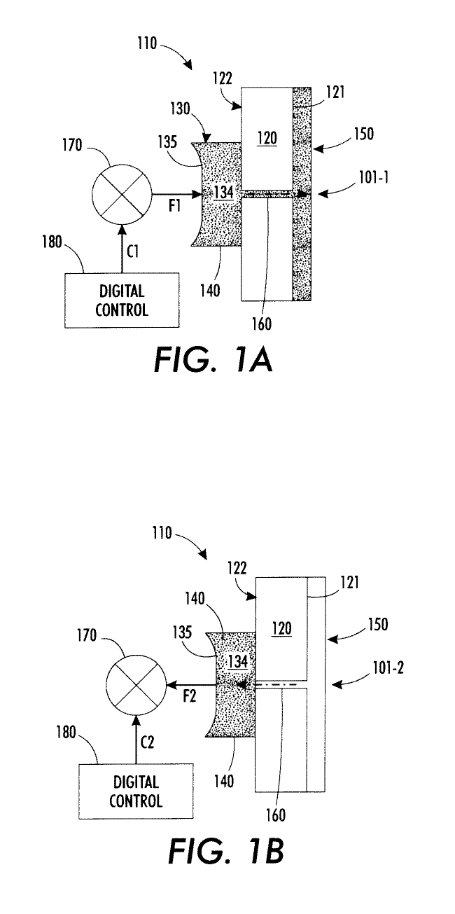

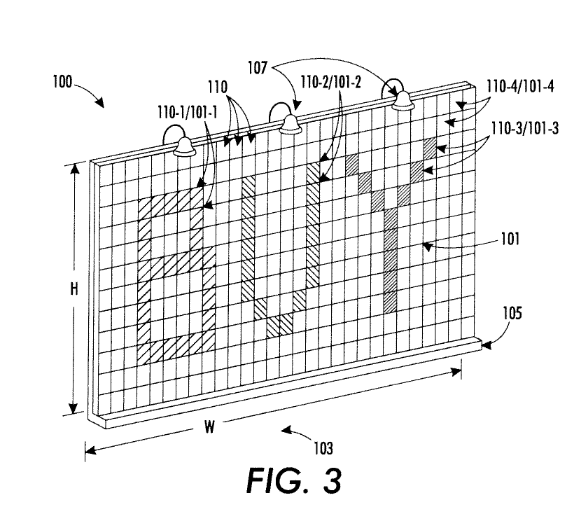

FIGS. 1(A) and 1(B) are cross-sectional side views showing a generalized microfluidic pixel 110 of a large format display (described below with reference to FIG. 3) according to the present invention. Pixel 110 includes a wall 120 having a front surface 121 and an opposing back surface 122, and a microfluidic system including a reservoir 130 disposed on a rear (first) side of the wall (i.e., facing back surface 122), a colorant fluid 140, at least one display chamber 150 disposed on a front (second) side of the wall (e.g., covering front surface 121), a conduit 160 that communicates between reservoir 130 and display chamber 150, and a fluid actuator 170 for transferring a portion of colorant fluid 140 between reservoir 130 and display chamber 150. Fluid actuator 170 receives a digital command signal from a digital control circuit 180, which is shared by a group of pixels (not shown), and is thereby actuated to transfer (pump) colorant fluid 140 between the reservoir 130 and the display chamber 150 by way of conduit 160.

In accordance with an aspect of the present invention, reservoir 130 includes a reservoir chamber 134 defined in part by a deformable wall (e.g., an elastomeric membrane) 135, and fluid actuator 170 includes a mechanism “means” for selectively applying a force F1 (shown in FIG. 1(A)) or a force F2 (shown in FIG. 1(B)) against deformable wall 135, thereby deforming or otherwise displacing deformable wall 135 (e.g., as shown in FIG. 1(A)) such that a portion of colorant fluid 140 is selectively transferred between the first reservoir 130 and display chamber 150 through conduit 160. For example, as shown in FIG. 1(A), upon receiving a first command signal C1 from digital control circuit 180, fluid actuator 170 generates force F1 that presses deformable wall 135 into reservoir chamber 134, thereby increasing the pressure inside reservoir chamber 134 such that colorant fluid 140 is forced through conduit 160 into display chamber 150. Conversely, as shown in FIG. 1(B), upon receiving a second command signal C2 from digital control circuit 180, fluid actuator 170 generates force F2 that pulls deformable wall 135 out of reservoir chamber 134 (or otherwise returns deformable wall 135 to an unstretched state), thereby decreasing the pressure inside reservoir chamber 134 such that colorant fluid 140 is drawn from display chamber 150 through conduit 160, and back into reservoir chamber 134.

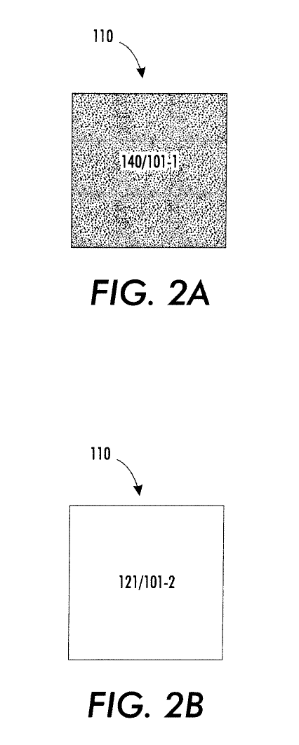

In accordance with an embodiment of the invention, display chamber 150 comprises a transparent structure that is disposed over front surface 121, and front surface 121 is painted or otherwise produced with a predetermined background appearance (e.g., white). With this arrangement, the appearance of pixel 110 is changeable between the “background” (first) appearance generated by front surface 121 in the absence of colorant fluid 140 in display chamber 150, and a “colored” (second) appearance 101-1 generated by the presence of colorant fluid 140 in display chamber 150. For example, FIGS. 1(A) and 1(B) illustrate a “colored” appearance 101-1 produced when colorant fluid 140 is transferred into display chamber 150, whereby front surface 121 is obscured by the portion of colorant fluid 140 disposed in display chamber 150. In contrast, as shown in FIGS. 2(A) and 2(B), a “background” appearance 101-2 is produced when substantially all of colorant fluid 140 is transferred into reservoir 130, whereby front surface 121 is viewed through the transparent structure defining display chamber 150.

FIG. 3 is a front side perspective view showing a large format display 100 including an array of microfluidic pixels 110, each constructed and operated as indicated in FIGS. 1(A) and 1(B), according to a simplified specific embodiment of the present invention. Display 100 is supported on a support structure, e.g., including a support base 103 and a support frame 105. Pixels 110 are arranged in rows and columns such that each pixel 110 forms a corresponding display surface portion of the overall two-dimensional display surface 101 of display 100. As such, the overall appearance of display surface 101 is selectively controlled by changing the appearance of each pixel 110. For example, as indicated by the simplified embodiment shown in FIG. 3, the appearance of display surface 101 is selectively controlled to display the word “BUY” by controlling selected first pixels 110-1 to produce darkened display surface portions 101-1 that collectively form a “B”, selected second pixels 110-2 to produce darkened display surface portions 101-2 that collectively form a “U”, selected third pixels 110-3 to produce darkened display surface portions 101-3 that collectively form a “Y”, and by controlling the remaining pixels 110-4 such that their associated display surface portions 101-4 produce the background appearance (e.g., white).

According to an aspect of the invention, microfluidic pixels 110 are produced almost entirely using polymer or other light-weight materials, thereby facilitating production of display 100 with a size and weight that is suitable replacing existing printed billboards without requiring modification to existing support structures. As used herein, the term “large format display” is utilized herein to designate a “billboard” type display that is manufactured for mounting onto a support structure (e.g., support base 103 and frame 105), and having a display surface 101 that has a width W of at least three ft. and a height H of at least three ft. Typical large format “bulletin” sized billboard displays have a width W of forty-eight ft. and a height H of fourteen ft.

According to alternative embodiments, display 100 is constructed to serve as a reflective type display (i.e., similar to conventional printed billboards), or constructed to operate as a transmissive (backlit) type display by forming wall 120 using light transmissive materials. When wall 120 is produced using opaque materials, display 100 is limited to reflective applications that are suited for sunny environments, and may be viewed at night using external lights (e.g., lamps 107, see FIG. 1) that are directed onto display surface 101. Accordingly, display 100 is suited for replacing existing printed billboards that utilize existing external lights similar to lights 107 shown in FIG. 3. In an alternative embodiment, wall 120 is produced using semi-transparent materials and a suitable backlight arrangement is provided that directs light through back surface 122, whereby display 100 operates as a transmissive type display such that display surface 101 “glows” without external lighting.

Additional features and details of large format display 100 are disclosed in co-owned and co-pending U.S. patent application Ser. No. ______, entitled “LARGE FORMAT MICROFLUIDIC DIGITAL DISPLAY”, which is incorporated herein by reference in its entirety.

In accordance with alternative specific embodiments of the present invention, fluid actuator 170 of each pixel 110 is implemented using a pump mechanism that only consumes power during an appearance change (e.g., changing the “colored” appearance of FIG. 1(A) to the “background” appearance of FIG. 1(B), changing the “background” appearance of FIG. 1(B) to the “colored” appearance of FIG. 1(A), or changing between two different “colored” appearances), and facilitates maintaining the selected appearance without requiring applied power. In the specific embodiments described below, an electrochemical pump mechanism is utilized to provide the desired operating functionality. In alternative embodiments (not shown), a similar operating functionality is producable using a piezoelectric mechanism, a differential (bimetallic) thermal expansion mechanism, a shape memory alloy mechanism, a shape memory alloy mechanism, electro-osmotic, thermopneumatic, hydrogel actuators, and valve array plus static pressure source, or other microfluidic actuation mechanisms known to those skilled in the art.

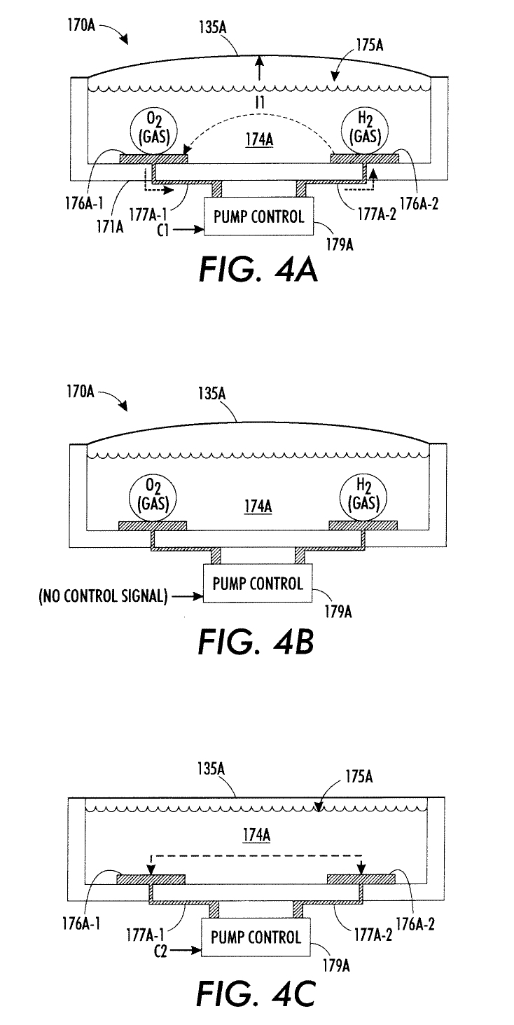

FIGS. 4(A)-4(C) are cross-sectional side views showing an electrochemical pump 170A of a pixel (not otherwise shown) according to a simplified specific embodiment of the present invention. Pump 170A includes an electrochemical cell formed by a rigid wall 171A that cooperates with a deformable wall 135A of pixel's reservoir (not shown) to define a pump chamber 174A containing an ionic solution 175A (e.g., an aqueous electrolyte solution including water plus ions, typically from base, acid or salt solute). A first (e.g., platinum) electrode 176A-1 and a second (e.g., platinum) electrode 176A-2 are disposed inside pump chamber 174A in a spaced apart arrangement. A pump control circuit 179A is connected to electrodes 176A-1 and 176A-2 by way of corresponding conductors 177A-1 and 177A-2, respectively, which pass through wall 171A. Pump control circuit 179A is constructed using known techniques to apply predetermined potentials, which are described below, to electrodes 176A-1 and 176A-2 in response to corresponding control signals (e.g., currents, voltages or charges).

In accordance with the embodiment shown in FIGS. 4(A) to 4(C), the actuation force for displacing deformable wall 135A in order to transfer colorant fluid from the associated reservoir to its associated display chamber (not shown) is generated by the production of gas. As indicated in FIG. 4(A), in response to a control signal C1, pump control circuit 179A applies a first potential to electrodes 176A-1 and 176A-2 in order to induce a current I1 through conductive solution 175A between electrodes 176A-1 and 176A-2, as indicated by the dashed curved arrow in FIG. 4(A). Current I1 causes the electrochemical cell to produce gas bubbles (e.g., hydrogen (H₂) and oxygen (O₂) gas bubbles), with the required current I1 for the electrochemical actuation being calculated, for example, as set forth in equations 1 to 4:

$$\begin{matrix}6 {H}_{2} O ⇔ 2 {H}_{2} + {O}_{2} + 4 {H}^{+} + 4 {OH}^{-} & Equation 1 \\ PV = NRT & Equation 2 \\ N = \frac{Q}{n F} = \frac{it}{n F} & Equation 3 \\ V = \frac{RTit}{nF P} & Equation 4\end{matrix}$$

where N is the moles of gas, R is the Universal gas constant, T is temperature, V is gas volume, P is gas pressure, i current I1, t is time (seconds), n is the number of electrons needed to produce one molecule of gas, and F is Faraday's constant. The required voltage needed to generate current I1 will be dependent on the series resistances of solution 175A, the solution/electrode interface, electrodes 176A-1 and 176A-2, and other electronic packaging resistances (i.e. traces, discrete devices, etc). As indicated in FIG. 4(A), the resulting gas generation increases the fluid pressure inside pump chamber 174A, thereby generating an actuation force that displaces deformable wall 135A outward. As described herein, the outward displacement of membrane 135A to pushes colorant fluid out of the associated reservoir (not shown) and into its associated display chamber. Control over the volume of colorant fluid is controllable by controlling the amount of generated gas, with relatively large volume transfers of the colorant fluid being achieved by producing larger quantities of hydrogen and oxygen gas by way of increasing the magnitude of current I1, or by maintaining current I1 for a longer period of time. In one embodiment, two gases (e.g., O₂ and H₂) generated by the electrochemical process are produced and stored in separate chambers, not mixed together.

As indicated in FIG. 4(B), gas production ceases upon the removal of the electrical potential applied to electrodes 176A-1 and 176A-2, which illustrates an advantage of electrochemical pump 170A in that deformable wall 135A remains stable in either operating state (i.e., in the expanded state shown in FIG. 4(B), or in the deflated state shown in FIG. 4(C)) as long as electrodes 176A-1 and 176A-2 are isolated (i.e., floating or separated by a very high external resistance) thereby allowing large area displays incorporating pixels using electrochemical pump 170A to be operated with very low power consumption, in comparison to conventional LED displays.

As indicated in FIG. 4(C), deflation of deformable wall 135A is achieved by applying a second control signal C2 to pump control circuit 179A. While control signal C2 is applied, pump control circuit 179A applies a second predetermined potential to electrodes 176A-1 and 176A-2 (e.g., pump control circuit 179A electrically shorts electrodes 176A-1 and 176A-2 together), thereby reversing the electrochemical reaction described above with reference to Equation 1 such that the hydrogen and oxygen gases are combined to form water. The resulting condensation of the gases into water reduces the volume of the fluid, and hence the pressure, in pump reservoir 174A. As the pressure in pump chamber 174A drops, the actuating force on deformable wall 135A is reduced, allowing displacement of deformable wall 135A toward pump chamber 174A. In one embodiment, the concomitant reduced pressure in the associated reservoir chamber (not shown) generates a partial vacuum that draws the colorant fluid out of the display chamber and behind the front surface wall, thereby changing the display appearance back to the white background appearance, as described above. In other embodiments, additional mechanisms are utilized to achieve complete return of the colorant fluid from the display chamber to the reservoir.

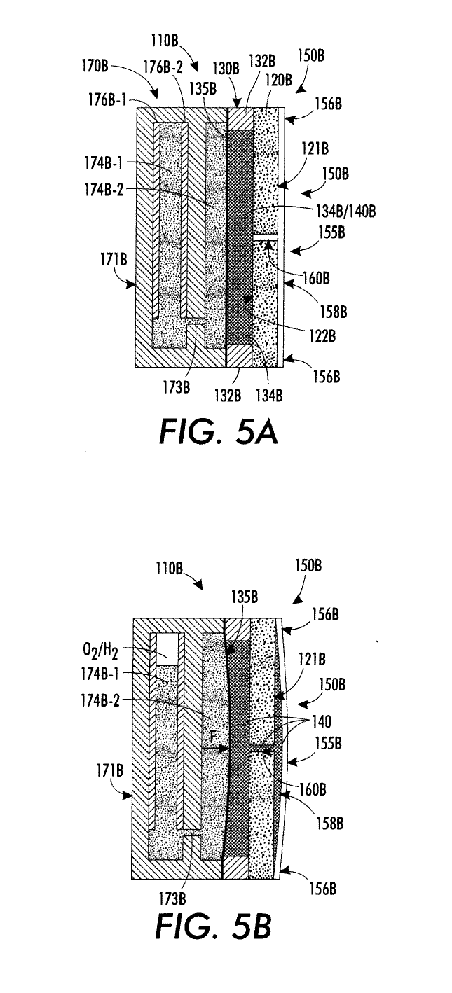

FIGS. 5-10 illustrate several simplified specific pixel constructions that utilize electrochemical pumps similar to that described above with reference to FIGS. 4(A) to 4(C). Those skilled in the art will recognize that variations to the specific pixel constructions are possible. Therefore, the described pixel constructions are intended to be illustrative, and not limiting to the claims unless the described structures are specifically recited.

FIGS. 5(A) and 5(B) are cross-sectional side views showing a pixel 110B including a bladder-type display chamber 150B and an electrochemical pump 170B according to a specific embodiment of the present invention.

Referring to the left side of FIG. 5(A), electrochemical pump 170B includes a rigid wall 171B that cooperates with a deformable wall 135B to define a first chamber portion 174B-1 having a first electrode 176B-1 and a second electrode 176B-2 disposed therein in a spaced apart relationship, a second chamber portion 174B-2 defined in part by deformable wall 135B, and a (second) conduit 173B communicating between lower regions of first chamber portion 174B-1 and second chamber portion 174B-2. This arrangement facilitates reliable displacement of deformable wall 135B by confining the gas generation process to first chamber portion 176B-1. That is, as indicated in FIG. 5(B), when O₂ and H₂ gas is generated by applying a potential across electrodes 176B-1 and 176B-2 in the manner described above, the gas floats to the top of first chamber portion 174B-1 (note that the O₂ and H₂ gases are typically stored in separate chambers). Because conduit 173B is located at the bottom of first chamber 174B-1, the pressure increase generated by the O₂ and H₂ gas only pushes (liquid) solution 175B through conduit 173B into second chamber portion 174B-2. As such, only (liquid) solution 175B is disposed against deformable wall 135B in both operating states, as shown in FIGS. 5(A) and 5(B). To increase the efficiency, it may be advantageous to separate the electrodes by a small distance only and by a medium that allows for high ion or electron mobility. An example of such as medium is Nafion® or other proton exchange membrane (PEM) materials known to those skilled in the art of fuel cells.

In accordance with another aspect of this embodiment, first chamber portion 174B-1 is elongated and extends in the vertical direction, and electrodes 176B-1 and 176B-2 extend vertically along substantially the entire length of first chamber portion 174B-1 such that portions of each electrode are disposed near the upper end of first chamber portion 174B-1. With this arrangement, the converted hydrogen and oxygen gas remains in contact with electrodes 176B-1 and 176B-2, thereby facilitating reliable reconversion of the gas into water.

Referring to the right side of FIGS. 5(A) and 5(B), pixel 110B further includes a wall 120B having a white front surface 121B and an opposing rear surface 122B, a reservoir including a frame 132B and deformable wall 135B that form a reservoir chamber 134B with rear surface 122B, a display chamber 150B disposed on front surface 121B, and a conduit 160B through wall 120B between reservoir 130B and display chamber 150B.

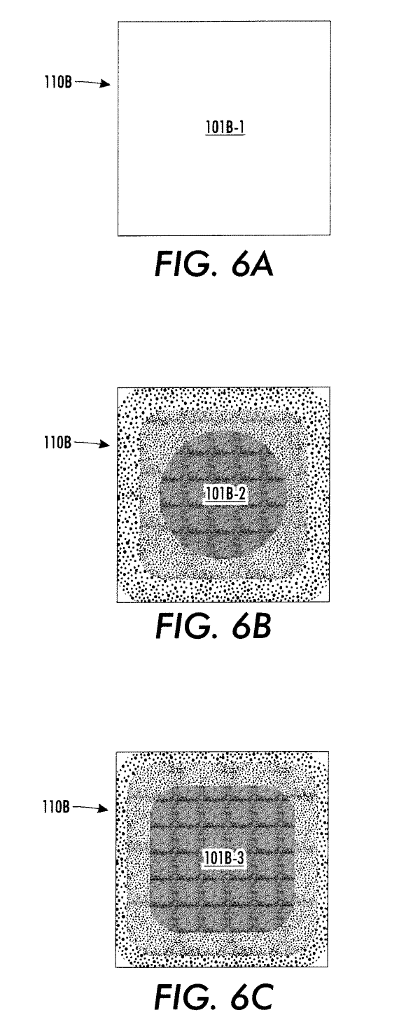

According to various embodiments set forth in related co-owned and co-pending U.S. patent application Ser. No. ______, entitled “LARGE FORMAT MICROFLUIDIC DIGITAL DISPLAY”, which is incorporated herein by reference in its entirety, pixel 110B is optimized for producing “black and white” (two color) displays, grayscale (multi-shaded) displays, and color displays having various display control features. In one specific embodiment, colorant fluid 140B is translucent (e.g., a color pigment suspended in a transparent liquid), and pump 170B is controlled such that the appearance of pixel 110B is changeable between light, medium and dark color shades. For example, FIGS. 5(A) and 6(A) show a background (or lightly shaded) appearance 110B-1 of pixel 110B in which none (or a very small amount) of colorant fluid 140B is disposed in display chamber 150B. As indicated in FIGS. 5(B) and 6(B), when pump 170B is actuated as described above to transfer a small amount of colorant fluid 140B into display chamber 150B, the appearance of display surface portion 101-2 is changed to a medium shaded color defined by a mixture of the white background appearance of front surface 121B and the small amount of colorant fluid 140B. As indicated in FIG. 6(C), when a larger amount of colorant fluid is transferred into the display chamber 150B, whereby the appearance of display surface portion 101-3 becomes a relatively dark shade that is dominated by the colorant fluid.

In accordance with another aspect of the embodiment shown in FIGS. 5(A) and 5(B), pixel 110B includes a bladder-type display chamber 150B including an elastomeric membrane 155B having a peripheral edge 156B that is secured (e.g., by adhesive) to front surface 121B of wall 120B, whereby the inside surface of the central region of elastomeric membrane 155B is resiliently pressed against the central region of front wall 121B when pixel 110B is in the first operating state, shown in FIG. 5(A), in which substantially all of colorant fluid 140B is disposed in reservoir 130B. As described above, in the first operating state, display surface portion 111B-1 has a white appearance produced by front wall 121B, as shown in FIG. 6(A). As indicated in FIG. 5(B), with this arrangement a pocket 158B is formed between elastomeric membrane 155B and front wall 121E for receiving colorant fluid 140B. In addition, conduit 160B includes one or more micro-channels defined wall 120B such that colorant fluid 140B passes between reservoir 130E and a central portion of display chamber 150B. In one embodiment, 250 μm circular through-holes are provided for a 10 mm pixel, where each hole connects to the display chamber on front side, and either directly to the reservoir chamber on the backside, or via more complex fluid pathways on the backside. More complex pathways can be made by laminating sheets together with appropriate slots or other cutouts in each layer. Cutouts and circular through holes can be made with laser cutting, die cutting or other mechanical (molding) or non-mechanical (e.g., etching or lithography) methods. As shown in FIG. 6(B), to produce a colored appearance, pump 170B applies pressing force F on deformable wall 135B, which deforms deformable wall 135B such that the reservoir chamber is collapsed, thereby forcing some colorant fluid 140B through conduit 160B against the inside surface of elastomeric membrane 155B. As colorant fluid 140B enters pocket 158B, membrane 155B expands outward, allowing colorant fluid 140B to cover inside surface 121B, whereby display surface portion 101B-2 (FIG. 6(B)) assumes a “colored” appearance. As the force F increases, more colorant fluid 140B is transferred into pocket 158B, causing elastomeric membrane 150B to expand further, which causes the “colored” appearance to darken, as indicated by appearance 101B-3 in FIG. 6(C). A reduction in the pump force F on deformable wall 135B will allow elastomeric membrane 155B to resiliently deform to its original (e.g., flat) shape, and colorant fluid 140B will travel through conduit 160B back into reservoir 130B. The variable displacement of colorant fluid 140B and elastomeric membrane 155B with respect to applied force F provides a range of predictable (and thus, reliably reproducible) colorant optical densities.

The present inventors feel bladder-type pixel 110B is inherently more significant for reflective large format displays, particularly those viewed from significant distance, that only require large pixels (e.g. 2 to 20 mm), and that only need to refresh slowly (e.g., in the range of 100 milliseconds to three minutes), and less so for small and/or fast switching pixels. That is, bladder-type pixels may not be suitable for pixels smaller than 1 mm pixels because they may not be producable at a reasonable cost. A possible limitation of bladder-type pixel 110B in other applications may be that coloration may be limited in the peripheral regions of front surface 121B. As indicated in FIGS. 6(B) and 6(C), due to the peripheral connection of elastomeric membrane 155B, a thicker layer of colorant fluid 140B is disposed in the central portion of pixel 110B than in the peripheral regions, whereby, as shown in FIGS. 6(B) and 6(C), display surface portions 101B-2 and 101B-3 have darker central regions and relatively wide peripheral regions that are substantially white. Another possible disadvantage of bladder-type pixel 110B is that it may be necessary to employ additional methods to completely pump colorant fluid 140B back into reservoir 130B. These methods may include surface chemistry modifications to the internal fluid structure of the colorant fluid. This may help to control and provide both wetting and dewetting conditions. One procedure would be to fill the pixel cavities with an optically clear oil first, then displace the oil with immiscible ink to make the pixel dark. The oil wants to wet the walls, the ink does not want to wet the walls. Expectation is that the plastic walls will always retain a very thin film of oil. The inventors believe this leads to more control, and also mitigates possible staining of the walls by the ink. Alternatively, a “zeroing” force maybe applied to the viewing side of the chamber bladder, which can be done by packaging/sealing the front side of the panels under a pressure higher than one atmosphere, so that the pixel pumps actuate against a Delta P. If necessary, a Delta P can also be applied by a conventional pump at the panel level. This zeroing force may be necessary to completely return the bladder to its original position and displace all of the colorant. This may be necessary in case the stretching force of the membrane or the stiffness of the diaphragm does not provide a large enough restoring force.

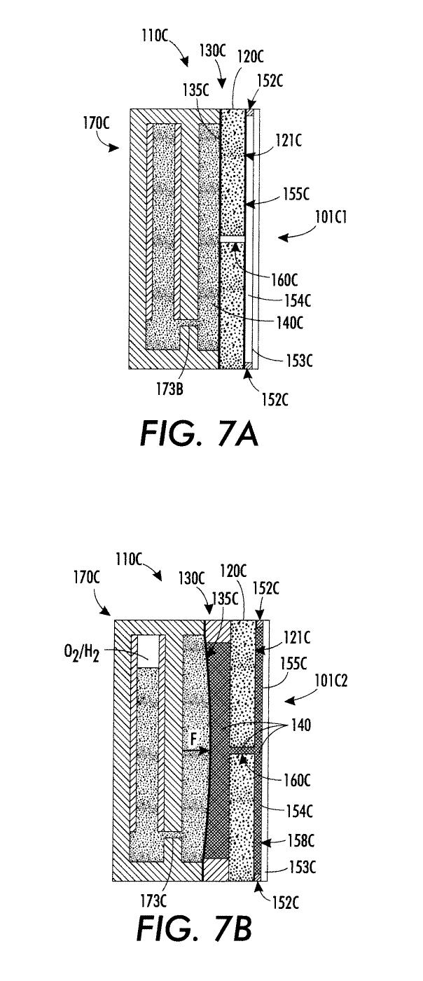

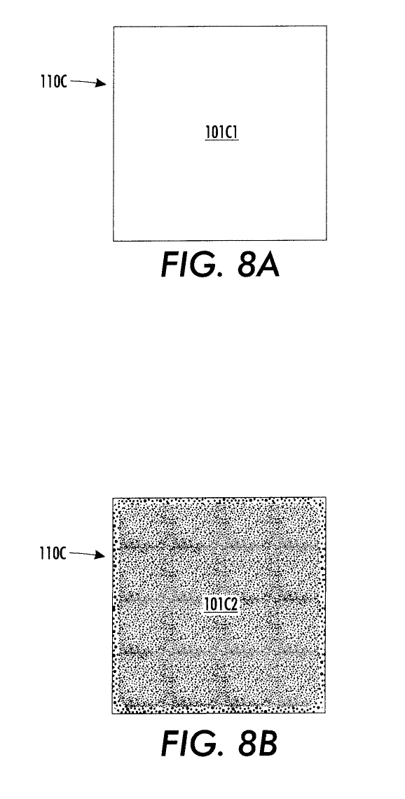

FIGS. 7(A) and 7(B) are cross-sectional side views showing a diaphragm-type pixel 110C according to another embodiment of the present invention that addresses the non-uniform coloration problem associated with bladder-type pixel 110C, and FIGS. 8(A) and 8(B) are front views showing the display surface of pixel 110C during operation. Diaphragm-type pixel 110C includes a wall 120C, a reservoir 130C, a colorant fluid 140C, a micro-channel conduit 160C, and an electrochemical pump 170C that are substantially identical to those of bladder-type pixel 110C (described above), and therefore the description of these components is omitted for brevity.

In accordance with an aspect of the present embodiment, display chamber 150C includes a peripheral frame 152C and a rigid transparent wall 153C that cooperate with front surface 121C of wall 120C to define a fixed volume chamber 154C, and a “baggie-type” membrane 155C having a peripheral edge 157C that is secured (e.g., by adhesive) to front surface 121C of wall 120C by frame 152C. Unlike elastomeric membrane 155C of bladder-type pixel 1100C membrane 155C is relatively flaccid when pixel 110C is in the first operating state, shown in FIG. 7(A), in which substantially all of colorant fluid 140C is disposed in reservoir 130C (i.e., display surface portion 101C-1 has a white appearance produced by front wall 121C, as shown in FIG. 8(A)). As shown in FIG. 7(B), to produce a colored appearance, pump 170C applies a pressing force F on reservoir 130C in the manner described above, thereby forcing colorant fluid 140C through conduit 160C against an inside surface of membrane 155C, causing colorant fluid 140C to begin to fill a pocket 158C defined between the inside surface of membrane 155C and front surface 121C. As colorant fluid 140C enters pocket 158C, membrane 155C expands outward to fill fixed volume chamber 154C, causing colorant fluid 140C to cover inside surface 121C, whereby display surface portion 101C-2 (FIG. 8(B)) assumes a “colored” appearance. Note that because the outward expansion of the membrane 155C is restricted by rigid transparent wall 153C, colorant fluid 140C forms in a substantially uniform thickness, as compared with that of bladder-type pixel 110B. As the force F increases, more colorant fluid 140C is transferred into pocket 158C, causing membrane 155C to expand such that it fills the entirety of fixed volume chamber 154C. Note that by providing a thin frame 152C, the uniform thickness of colorant fluid 140C extends to nearly the outermost periphery of pixel 110C, whereby a fill-factor of diaphragm-type pixel 110C is believed to be greater than that of bladder-type pixel 110B. A subsequent reverse of the pump force on deformable wall 135C causes membrane 155C to deform to its original (e.g., flat) shape, and colorant fluid 140C travels through conduit 160C back into reservoir 130C.

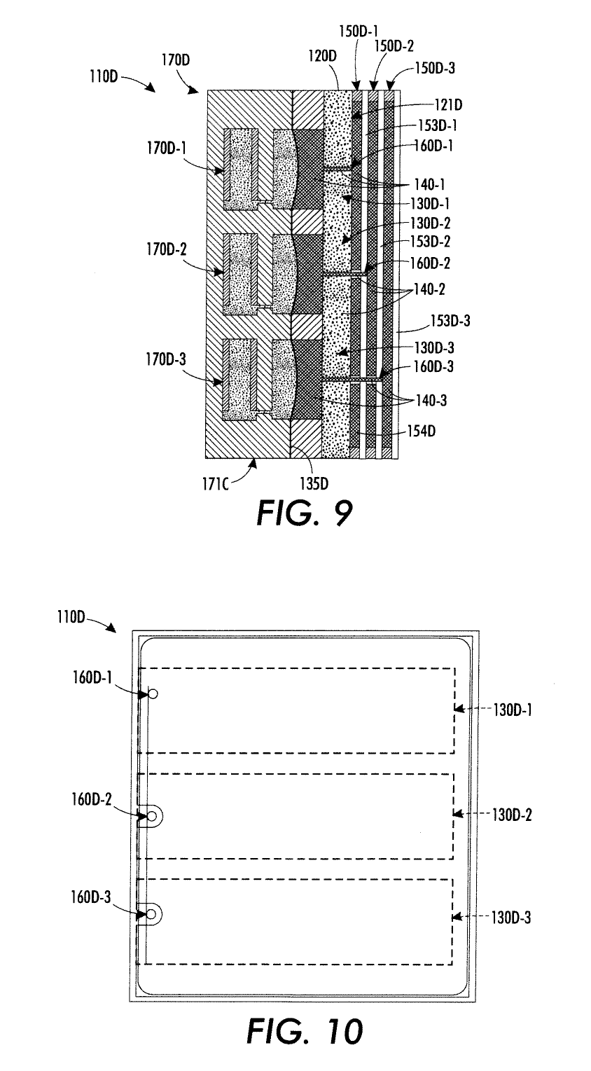

In addition to exhibiting a more uniform appearance and greater fill-factor, another advantage of diaphragm-type cell 110C over bladder-type cell 110B (see FIG. 5(A)) is that diaphragm-type cell 110C more easily facilitates stacking for generating spatially serial display chamber configurations used for CMY color pixels, as described below with reference to FIGS. 9 and 10.

FIGS. 9 and 10 are cross-sectional side and front views, respectively, showing a color diaphragm-type pixel 110D according to another simplified specific embodiment of the present invention. Pixel 110D is illustrated with three independent microfluidic systems for transferring three different colorant fluids 140D-1 to 140D-3 between three separate reservoirs 130D-1 to 130D-3 and three display chambers 150D-1 to 150D-3 using the techniques described above. As indicated in FIG. 9, reservoirs 130D-1 to 130D-3 are arranged in a spatially parallel arrangement, and are subjected to separate pump forces F1 to F3 generated by associated pumps 170D-1 to 170D-3, each operating in the manner described above in response to associated control signals (not shown). Each display chamber 150D-1 to 150D-3 is substantially identical to display chamber 150C of diaphragm-type pixel 110C, discussed above, but are stacked in a spatially serial arrangement such that first display chamber 150D-1 is mounted onto front surface 121D in the manner described above, second display chamber 150D-2 is mounted onto a front surface of transparent rigid wall 153D-1, and third display chamber 150D-3 is mounted onto a front surface of transparent rigid wall 153D-2. With this arrangement, each display chamber 150D-1 to 150D-3 is independently operated substantially as described above with reference to diaphragm-type pixel 110C to produce a selected color (e.g., CMY) display.

Large format displays (e.g., display 100, see FIG. 3) that incorporate an array of pixels 110D include a digital control circuit that generates three distinct control signals (currents) for independently controlling pumps 170D-1 to 170D-3 of each pixel 110D, whereby display surface portion of pixel 110D is selectively changeable between a white background appearance, which is generated when substantially all of colorant fluids 140D-1 to 140D-3 are respectively transferred into reservoirs 130D-1 to 130D-3, and a colored appearance generated when a selected amount of at least one of colorant fluids 140D-1 to 140D-3 is transferred into its associated display chambers 150D-1 to 150D-3, respectively. Those skilled in the art will recognize that, as described in U.S. application Ser. No. ______, entitled “LARGE FORMAT MICROFLUIDIC DIGITAL DISPLAY (referenced above), by varying the amount of CMY colorant fluid in each of the display chambers, a wide range of visible colors are displayable by each pixel 110D.

As set forth above, each color pixel requires three distinct actuation currents (and associated control signals) to achieve a unique CMY color. In accordance with another aspect of the invention, these three distinct actuation currents are achieved using passive matrix addressing in which the electrochemical energy at each matrix element will be supplied through a set of localized capacitors in order to reduce the instantaneous power requirements. The invention is inherently more significant for reflective displays that only require large pixels (e.g. 1 to 20 mm) that only needs to refresh slowly (e.g., 100 ms to approximately 3 minutes), less so for smaller and/or faster switching pixels.

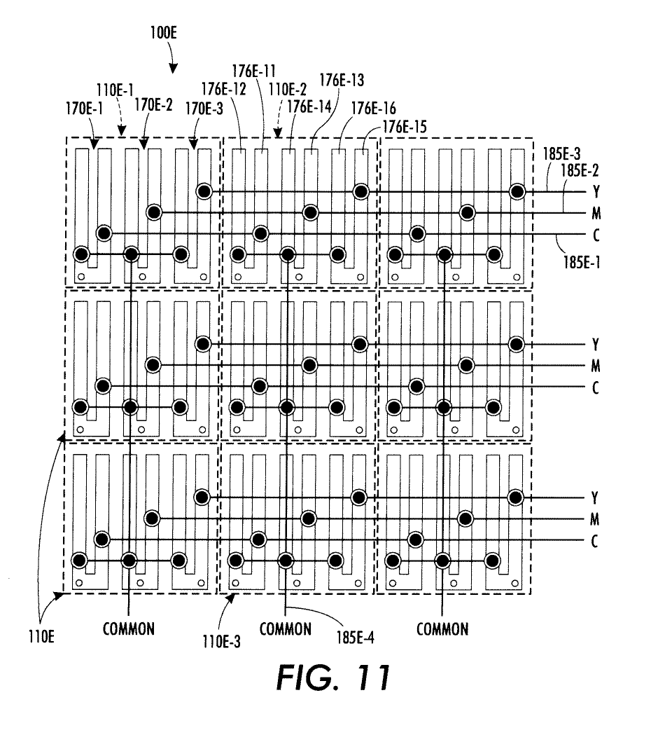

FIG. 11 is a simplified schematic diagram showing the backside of a large format display 100E including a passive matrix addressing arrangement for electrically addressing an array of the CMY pixels 110E according to another embodiment of the present invention. CMY pixels 110E are arranged in columns and rows (e.g., pixels 110E-1 and 110E-2 are in the same row, and pixels 110E-2 and 110E-3 are in the same column). As described above with reference to FIGS. 9 and 10, each pixel includes three electrochemical pumps (e.g., pixel 110E-1 includes pumps 170E-1, 170E-2 and 170E-3) for controlling each of the three (i.e., CMY) colorant fluids. Each pump includes both positive and negative electrodes (e.g., a first pump of pixel 110E-2 includes positive electrode 176E-11 and negative electrode 176E-12, a second pump includes positive electrode 176E-13 and negative electrode 176E-14, and a third pump includes positive electrode 176E-15 and negative electrode 176E-16). Each of the three positive electrodes in each row are connected to corresponding horizontal conductors that transmit associated CMY control signals, and the negative electrodes in each column are connected to a corresponding vertical conductor that transmits associated “common” control signals. For example, positive electrode 176E-11 receives a “C” control signal on conductor 185E-1, positive electrode 176E-13 receives a “M” control signal on conductor 185E-3, and positive electrode 176E-15 receives a “Y” control signal on conductor 185E-3. Negative conductors 176E-2, 176E-4 and 176E-6 receive “COMMON” control signals transmitted on conductor 185-4. Note that the black dots with a circle around them symbolize the electrodes, and the U-shaped pump structures depicted in FIG. 11 are U-shaped fluid channels with one leg for capturing O₂ and one leg for capturing H₂ gas such that the two gases are kept separate from each other. Note also that diodes are required in each “common” line to facilitate the passive matrix. Those skilled in the art will recognize that each pump of each pixel 110E is independently addressable using this passive matrix addressing arrangement, and additional addressing schemes, other that those disclosed herein, may be utilized.

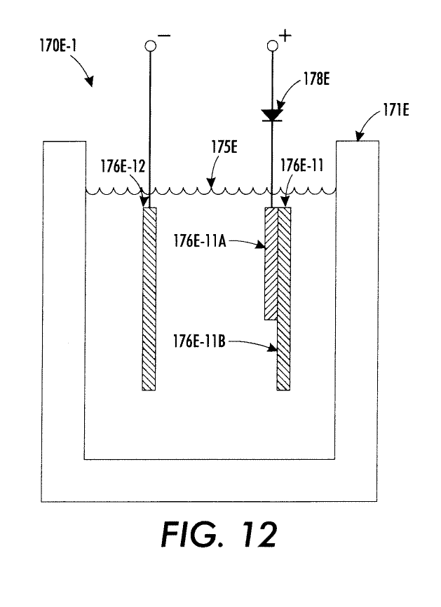

FIG. 12 shows an exemplary pump 170E-1 of display 100E (see FIG. 11) in additional detail. Pump 170E-1 includes an outer wall 171E containing an aqueous fluid 175E, and includes a negative electrode 176E-12 and a positive electrode 176-11 that are disposed in solution 175E and are addressed in the manner described above. According to another aspect of the present embodiment, negative electrode 176E-12 comprises at least an outer layer including platinum, nickel, or a platinum/nickel alloy that serves as a catalyst for hydrogen generation, and positive electrode 176E-11 comprises a series of thin films including a platinum/nickel surface layer 176E-11A that serves as a catalyst for oxygen generation, and a base structure 176E-11B including a series of metallization (e.g., aluminum) and dielectric layers that are implemented in a capacitive structure. An optional diode 178E or transistor is provided in series with positive electrode 176E-11 in order to control current flow within the matrix structure. This is effectively a built-in electrolytic capacitor.

Large format displays produced in accordance with the various embodiments disclosed above provide multiple advantages over conventional printed and LED billboards. A primary advantage is weight. Because large format devices are primarily constructed using polymer and are relatively thin, their weight will be significantly less than their LED counterparts. This will allow for currently grandfathered billboards to be retrofitted without significant regulatory interaction. Moreover, the CMY color basis provided by the spatially serial arrangements described herein will provide for a wider color gamut than RGB based designs. The layered construction can also be modularized so that repair of defective or malfunctioning sections of a display is easy, cheap and fast (i.e., by replacing one pixel or a panel of pixels). The reflective pixels use light sources that are in place and accepted by local governments, and are therefore suited for sunny environments and the viewing quality is less susceptible to weather conditions. When used in combination with the electrochemical pump mentioned herein, the electrolysis provided by the electrochemical pump is bistable, and color actuation occurs by applying a given amount of electrical energy. The generated bubbles are stable, so the color remains unchanged without the subsequent application of energy, i.e., the color remains stable until a selected current is applied. This offers significantly cheaper operation versus other digital billboard methods. Another advantage is that the manufacturing methods used to produce the various pixels are simple and conventional.

Although the present invention has been described with respect to certain specific embodiments, it will be clear to those skilled in the art that the inventive features of the present invention are applicable to other embodiments as well, all of which are intended to fall within the scope of the present invention. For example, although the present invention is described herein as utilizing fluidic actuators to displace elastomeric membranes in order to displace colorant fluid, the fluidic actuators may achieve this function without the use of elastomeric membranes. In addition, in an alternative embodiment a solid ionic conductor, for example a proton exchange membrane, may be used as the electrolyte, and a fluid, i.e. water, hydrogen and oxygen, may be used to supply the reactants for the forward and reverse electrochemical reactions.

1. A display having a display surface formed by a plurality of pixels arranged in an array such that each pixel forms a corresponding display surface portion, wherein each pixel comprises:
a wall including a front surface on a first side and a back surface on an opposing second side; and
a first microfluidic system including:
a first reservoir disposed on the first side of the wall, the first reservoir including a reservoir chamber defined in part by a deformable wall;
a first colorant fluid disposed in the first reservoir;
a first display chamber disposed on the second side of the wall;
a first conduit communicating between the first reservoir and the first display chamber; and
a first fluid actuator including means for selectively transferring a portion of the first colorant fluid between the first reservoir and the first display chamber through the first conduit.

2. The display of claim 1,
wherein the first display chamber comprises a transparent structure disposed over the front surface such that said front surface is viewable through said first display chamber, and
wherein the display further comprises a digital control circuit and a backplane for transmitting control signals to the first fluid actuator of each of the plurality of pixels, whereby the corresponding display surface portion of said each pixel is selectively changeable between a predetermined first appearance generated by the front surface when substantially all of said first colorant fluid is transferred into the first reservoir, and a second appearance generated when a selected amount of said first colorant fluid is transferred into said first display chamber.

3. The display of claim 1, wherein the display surface has a width of at least three ft. and a height of at least three ft.

4. The display of claim 1,
wherein the reservoir chamber comprises a reservoir chamber that is defined in part by an elastomeric membrane, and
wherein the first fluid actuator including means for selectively displacing the deformable wall.

5. The display of claim 4, wherein the first fluid actuator comprises a mechanism that only consumes power during selective displacement of the deformable wall.

6. The display of claim 4,
wherein the display further comprises a digital control circuit and a backplane for transmitting control signals to each of the plurality of pixels, and
wherein the first fluid actuator comprises at least one rigid wall that cooperates with the deformable wall to define a pump chamber containing an electrolyte solution, two electrodes disposed inside the pump chamber, and a pump control circuit for applying predetermined potentials to the electrodes in response to corresponding control signals received from said digital control circuit.

7. The display of claim 6, wherein the pump control circuit of each of the plurality of pixels includes:
means for applying a predetermined first potential across the two electrodes in response to a first control signal received from said digital control circuit, whereby a portion of the electrolyte solution is converted to gas, and
means for applying a predetermined second potential across the two electrodes in response to a second control signal received from said digital control circuit, whereby said gas in the pump chamber is converted to liquid.

8. The display of claim 7, wherein the pump chamber comprises a first chamber portion having said two electrodes disposed therein, a second chamber portion defined in part by said deformable wall, and a second conduit communicating between said first chamber portion and said second chamber portion, the second conduit being disposed at a lower end of said first chamber portion, whereby said converted gas is confined to said first chamber portion and contacts said two electrodes.

9. The display of claim 8, wherein the first chamber portion is elongated in a vertical direction, and portions of said two electrodes are located at upper ends of the first chamber portion substantially along vertically within said first chamber portion.

10. The display of claim 6,
wherein the first colorant fluid of each of said plurality of pixels is translucent, and
wherein the digital control circuit comprises means for controlling the first fluid actuator of each of said plurality of pixels such that said corresponding display surface portion is selectively changeable between a relatively light shade, a relatively dark shade, and a medium shade that is between the relatively light shade and the relatively dark shade.

11. The display of claim 6, wherein the first conduit comprises one or more micro-channels defined through the wall.

12. The display of claim 11, wherein the first display chamber comprises a second elastomeric membrane having a peripheral edge that is secured to the front surface of the wall, whereby an inside surface of the second elastomeric membrane is resiliently pressed against the front surface when substantially all of said first colorant fluid is transferred into the first reservoir.

13. The display of claim 11, wherein the first display chamber comprises a first fixed volume chamber defined by the front surface, a first peripheral frame, and a first rigid transparent wall mounted on the frame, and a first membrane disposed in the fixed volume chamber and having a peripheral edge that is secured to the front surface of the wall, whereby said first colorant fluid passing through the first conduit enters a first pocket defined between the first membrane and the front surface, and an outward expansion of the first membrane is restricted by the first rigid transparent wall.

14. The display of claim 13, further comprising at least one additional microfluidic system, each of said at least one microfluidic systems including an associated reservoir disposed on the first side of the wall, an associated colorant fluid, an associated transparent second display chamber disposed on the second side of the wall, an associated conduit communicating between the associated reservoir and the associated display chamber, and an associated fluid actuator for selectively transferring the associated colorant fluid between the associated reservoir and the associated display chamber, wherein the first display chamber and the at least one associated display chamber are disposed in a spatially serial relationship such that said front surface is only viewable through at least one of said first display chamber and said at least one associated display chamber.

15. The display of claim 14,
wherein the at least one additional microfluidic system includes a second microfluidic system including a second colorant fluid and a second display chamber, and a third microfluidic system including a third colorant fluid and a third display chamber, and
wherein the first, second and third display chambers are arranged in a spatially serial configuration such that front surface is only viewable through each of said first, second and third display chambers.

16. The display of claim 15, wherein the first colorant fluid comprises a first translucent fluid including a cyan dye, the second colorant fluid comprises a second translucent fluid including a magenta dye, and the third colorant fluid comprises a third translucent fluid including a yellow dye.

17. The display of claim 14,
wherein said second microfluidic system includes a second fluid actuator and said third microfluidic system includes a third fluid actuator, and
wherein said digital control circuit comprises means for controlling said first, second and third fluid actuators, whereby the corresponding display surface portion of said each pixel is selectively changeable between a predetermined appearance generated when substantially all of said first, second and third colorant fluids are respectively transferred into the first, second and third reservoirs, and a second appearance generated when a selected amount of at least one of said first, second and third colorant fluids is transferred into an associated one of said first, second and third display chambers, respectively.

18. The display of claim 1, wherein the display includes passive or active matrix addressing circuit including a horizontal conductor connected to a first electrode of said two electrodes, and a vertical conductor connected to a second electrode of said two electrodes.

19. The display of claim 18, wherein each of the electrodes comprises platinum, and at least one of the electrodes comprises a capacitor.
